(19) United States
(12) Patent Application Publication
(10) Pub. No.: US 2023/0061400 A1
(43) Pub. Date: Mar. 2, 2023

(54) CABLE PATH PLANNING METHOD AND APPARATUS

(71) Applicant: City University of Hong Kong, (US)

(72) Inventors: Moshe ZUKERMAN, Hong Kong (HK); Zengfu WANG, Xi?an City (CN); Xinyu WANG, Yongji City (CN); Elias TAHCHI, Singapore (SG)

(21) Appl. No.: 17/411,093

(22) Filed: Aug. 25, 2021

(51) Int. Cl. H04L 12/24; H04L 12/733

(52) U.S. Cl. CPC H04L 41/145; H04L 45/122; H04L 41/22; H04L 41/0826

(57) ABSTRACT

The present invention provides a cable planning method based a fast marching method applied with simulated annealing (FMM/SA) algorithm. In the FMM/SA algorithm-based cable planning method, the FMM used to obtain the optimal submarine cable path with the lowest life-cycle cost, and the SA algorithm is used to continuously adjust the weight of each design consideration with the aim to achieve an optimal cable path that is as close as possible to a real-life cable path which has a history of cost-effectiveness and resilience. The set of weights contributed to the optimal cable path is then used as an optimal set of weights of design considerations for cable path planning. The FMM/SA algorithm-based cable planning method can provide a computationally effective approach which has lower computation costs and better performance in generating cable paths with optimal life-cycle cost and reliability.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention generally relates to cable path planning. More specifically, the present invention relates to weight selection of design considerations for submarine cable path planning.

### BACKGROUND OF THE INVENTION

With recent technology push and demand pull mainly linked to the introduction of 5G technology and the COVID-19 outburst, there is continuous growth in global data and network traffic and it is challenging to sustain capacity growth of submarine cables. However, the laying and maintenance of submarine cables are costly and vast submarine cable systems are prone to faults. To design a cost-effective and resilient submarine cable network, it is required to consider various factors that may cause the submarine cable to break, including natural and anthropological activities. In reality, a resilient and cost-effective submarine cable's path design is achievable by considering a range of factors. Industry experts conduct multiple routes and engineering surveys and constantly modify the cable path meter by meter manually to balance the various considerations. This process is highly time-consuming and expensive.

There has also significant fundamental research done on submarine cable path planning. Most of the existing work on path planning of submarine cables focuses on path optimization under a specific factor. In addition to the earthquake factor that is usually considered, there are many other factors that may affect the cost and reliability of submarine cables that should be considered.

Therefore, there is an unmet need for a cable path planning method which can take into account various considerations that may affect the cost and reliability of submarine cables so as to produce cost-effective and reliable real-life submarine cable path design within an acceptable time frame.

### SUMMARY OF THE INVENTION

According to one aspect of the present invention, the present invention provides a method for cable path planning. The method comprises: deriving an optimal set of weights of design considerations from an optimal virtual cable path generated between a reference start point and a reference end point in a reference manifold under an objective of minimizing a life-cycle cost modelled with one or more design considerations and minimizing a discrete Fréchet distance with respect to a reference cable path; and determining an optimal path arrangement for the infrastructure cable over the target terrain based on the derived optimal set of weights of design considerations.

According to another aspect of the present invention, the present invention provides a cable planning method using a fast marching method (FMM) based on simulated annealing (SA) (FMM/SA) algorithm. In the FMM/SA algorithm, FMM is used to obtain the optimal submarine cable path with the lowest life-cycle cost, and SA algorithm is used to continuously adjust the weight of each design consideration with the aim to achieve an optimal cable path that is as close as possible to a real-life cable path which has a history of cost-effectiveness and resilience. The set of weights contributed to the optimal cable path is then used as an optimal set of weights of design considerations for cable path planning.

Compared with other types of FMM algorithms such as the FMM algorithm based on random-restart hill-climbing (FMM/RRHC) and the FMM algorithm based on Monte Carlo's idea (FMM/MC), the FMM/SA algorithm based cable planning method can provide a computationally effective approach which has lower computation costs and better performance in generating cable paths with optimal life-cycle cost and reliability.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments of the invention are described in more detail hereinafter with reference to the drawings, in which:

FIG. 1 depicts a flowchart of a cable path planning method in accordance with a preferred embodiment of the present invention;

FIG. 2 depicts a flowchart of a method for the derivation of an optimal set of weights of design considerations;

FIG. 3 depicts a flowchart of a fast marching method applied for obtaining the initial virtual path;

FIG. 4 depicts a flowchart of a simulated annealing algorithm for obtaining the best set of weights of design considerations;

FIGS. 5A-5C depict a flowchart of an iteration of the simulated annealing algorithm;

FIG. 6 shows an exemplary implementation of the FMM/SA algorithm;

FIG. 7 shows an exemplary apparatus that can be used as a server or other information processing systems in one embodiment of the invention for performing or implementing the method in the invention;

FIG. 8A illustrates the topology of the Southern Cross NEXT, and FIG. 8B shows the Cable SX drawn using ArcGIS;

FIG. 9A shows the topology of the South America-1, and FIG. 9B shows the Cable SAm drawn using ArcGIS;

FIGS. 10A-10D show elevation map, geological hazards, seagrass map, and coral beefs map around Cable SX, respectively;

FIGS. 11A-11D show elevation map, geological hazards, seagrass map and coral beefs map around Cable SAm, respectively;

FIG. 12 shows a marching process for a cable path generated by the FMM/SA algorithm;

FIG. 13A shows the curves of cable paths generated by the FMM/SA algorithm under different sets of weights of design considerations obtained at different running times; and FIG. 13B shows a partially enlarged view of FIG. 13A;

FIG. 14A shows curves of cable paths generated by FMM/SA, the FMM/RRHC, and FMM/MC with the data of Cable SX; and FIG. 14B shows a partially enlarged view of FIG. 14A;

FIG. 15A shows curves of cable paths generated by the FMM/SA, the FMM/RRHC and the FMM/MC algorithms with the data of Cable SAm, and FIG. 15B shows a partially enlarged view of FIG. 15A; and

FIG. 16 shows a histogram of the geodesic distances between the data points from Cable SAm and a cable path generated by the FMM/SA.

### DETAILED DESCRIPTION

In the following description, a method and a system for optimizing a cable path design and the likes are set forth as preferred examples. Specific details may be omitted so as not to obscure the invention; however, the disclosure is written to enable one skilled in the art to practice the teachings herein without undue experimentation.

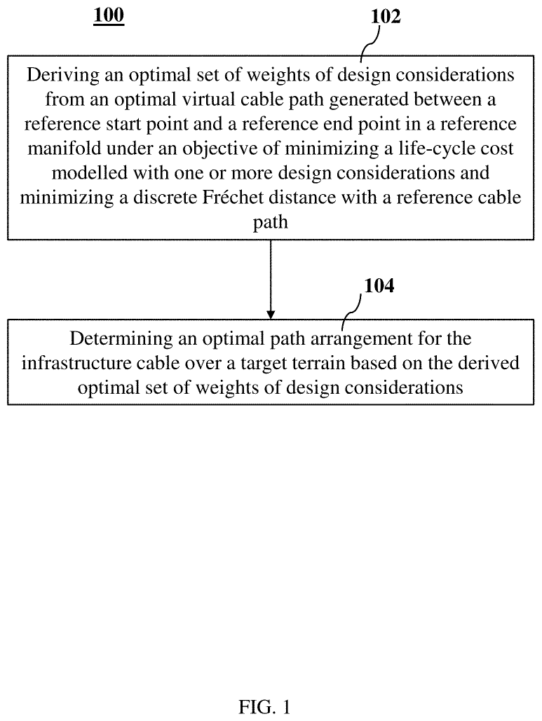

FIG. 1 depicts a flowchart of a cable path planning method 100 in accordance with a preferred embodiment of the present invention. Referring to FIG. 1. The method 100 comprises a step 102: deriving an optimal set of weights of design considerations from an optimal virtual cable path generated between a reference start point and a reference end point in a reference manifold under an objective of minimizing a life-cycle cost modelled with one or more design considerations and minimizing a discrete Fréchet distance with respect to a reference cable path; and a step 104: determining an optimal path arrangement for an infrastructure cable over a target terrain based on the derived optimal set of weights of design considerations.

Preferably, the reference cable path is a real-life cable between two geographic locations and with a history of resilience and cost-effectiveness. The reference start point and the reference end point are the two geographic locations, respectively. The reference manifold may be obtained by modelling an earth surface between the two geographic locations into a triangulated piecewise-linear two-dimensional manifold M in R³. Each point on M is denoted by a three-dimensional coordinate (x, y, z), where z=ξ(x, y) is the elevation corresponding to a geographic location (x, y).

In addition to basic construction cost consideration (including cable length) as well as considerations for cable resilience (including geological hazards like earthquakes and volcano eruptions, anthropological hazards like fishing and anchoring activities), there are other cable design considerations that are taken into account in cable path planning. Such considerations include but not limited to restricted/protected areas, existing cables/pipelines, seabed slope, water depth, shield level for cables.

The reference cable path may be denoted as U and represented by a sequence of points {u₁, u₂, . . . , uₚ}, where p is the number points in U. A virtual cable path may be denoted as V and represented by a sequence of points {v₁, v₂, . . . , v_{q}}, where q is the number of points in U. Without loss of generality, it is assumed that the number of points in U is larger than the number of points in V, namely, p>q.

The virtual path curve V with the minimal total life-cycle cost may be obtained by solving a first optimization problem:

$${min}_{V} C ( V ) ,$$

where C(V) is the life-cycle cost function for the virtual cable path V.

The total life-cycle cost for the virtual cable path V may be given by:

C(V)=∫₀^{l(V)}C(X(t))dt,

where l(V) is the total length of the virtual cable path V, c(X(t)) is a life-cycle cost function per unit length at a location X(t) formulated with a length t of a very small arc segment of the cable path V.

The life-cycle cost function per unit length may be constructed based on a K number of design considerations and given by:

C(X)=Σₖ₌₁^{K}wₖcₖ(X),

where cₖ (X) represent the cost function of design consideration k at location X and wₖ is the weight of design consideration k, and k=1, 2, . . . , K.

Then, the optimal virtual cable path can be obtained by solving a second optimization problem defined as:

$${min}_{W ∈ {R}_{+}^{K}} {δ}_{dF} ( U , V ) , subject to {\sum }_{k = 1}^{K} {w}_{k} = 1 ,$$

where δ_{dF}(U, V) represents the discrete Fréchet distance of the virtual cable path with respect to the reference cable path, and W represents sets of weights of design considerations used for obtaining the discrete Fréchet distance, and R₊^{K} is the feasible solution space for the sets of weights of design considerations.

The discrete Fréchet distance may be given by:

$${δ}_{dF} ( U , V ) = {min}_{s ∈ S} ( {max}_{i = 1 , … , p} d ( {u}_{i} , {v}_{{a}_{i}} ) ) ,$$

where s={(uᵢ, vₐᵢ)} represents a sequence of pairs of points generated based on the rules: (1) for any two points uᵢ and uⱼ in U, if i<j, then aᵢ≤aⱼ; (2) every point vⱼ in V should be used to form a pair; S is a set of all possible sequences of pairs of points (uᵢ, vₖ) paired with points from U and V respectively; and d(uᵢ, vₐ_{ᵢ}) is the geodesic distance between a pair of points uᵢ and vₐ_{ᵢ} from s.

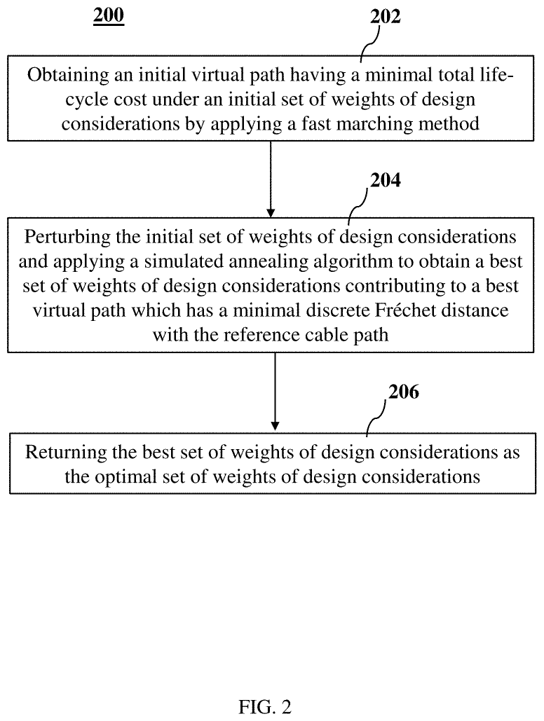

FIG. 2 depicts a flowchart of a method 200 for the derivation of the optimal set of weights of design considerations. Referring to FIG. 2, the derivation of the optimal set of weights of design considerations may comprise: a step 202: obtaining an initial virtual path having a minimal total life-cycle cost under an initial set of weights of design considerations W₀ by applying a fast marching method; a step 204: perturbing the initial set of weights of design considerations W₀ and applying a simulated annealing algorithm to obtain a best set of weights of design considerations contributing to a best virtual path which has a minimal discrete Fréchet distance with respect to the reference cable path; and a step 206: returning the best set of weights of design considerations as the optimal set of weights of design considerations.

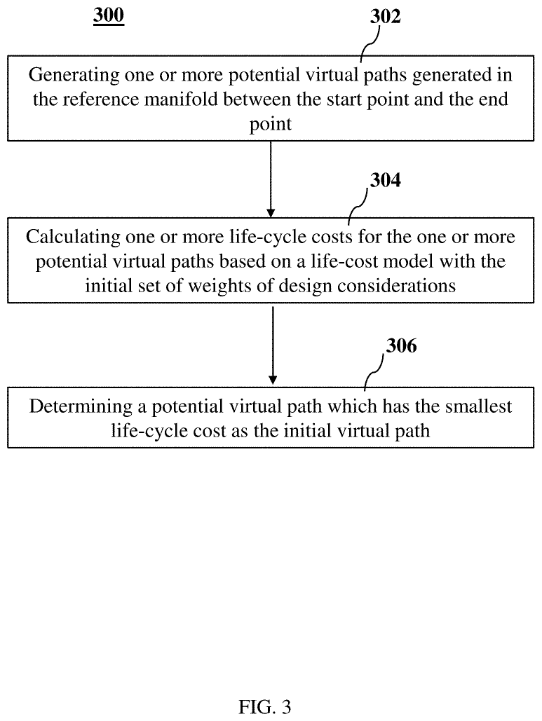

FIG. 3 depicts a flowchart of a fast marching method 300 applied for obtaining the initial virtual path. Referring to FIG. 3, the fast marching method may comprise: as a step 302: generating one or more potential virtual paths generated in the reference manifold between the start point and the end point; a step 304: calculating one or more life-cycle costs for the one or more potential virtual paths based on a life-cost model with the initial set of weights of design considerations W₀; and a step 306: determining a potential virtual path which has the smallest life-cycle cost as the initial virtual path.

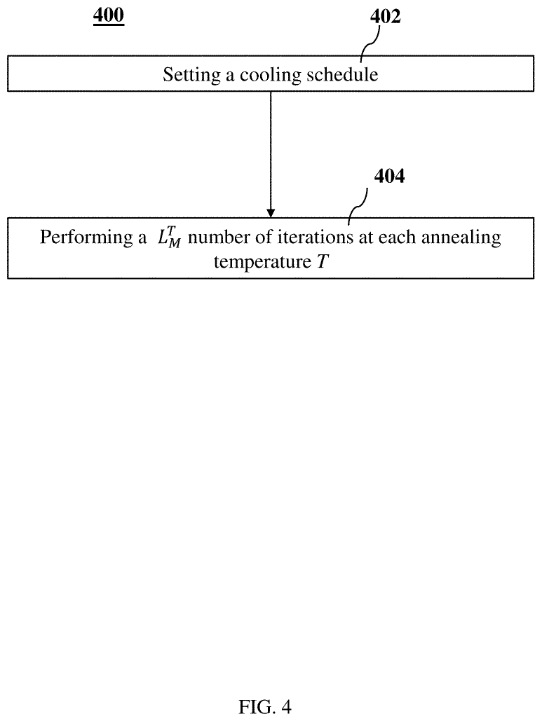

FIG. 4 depicts a flowchart of a simulated annealing algorithm 400 for obtaining the best set of weights of design considerations. Referring to FIG. 4, the simulated annealing algorithm 400 comprises a step 402: setting a cooling schedule consists of an initial cooling temperature T₀, a termination temperature of cooling T_{f}, a number of annealing temperatures between T₀ and T_{f}; and a maximum number of iterations (i.e., the length L_{M}^{T} of the Markov chain) to be formed at each annealing temperature; and a step 404: performing a L_{M}^{T} number of iterations at each annealing temperature T.

The annealing temperature may be defined by a function:

T(r)=Tₒφ^{r}^{^{1/D}},

where T(r) is the annealing temperature, r is the number of temperature attenuation, D is the dimension of the state space and φ is a non-negative real number. In various embodiments, the dimension of the state space D is equal to 1 or 2, and non-negative real number φ has a value ranging from 0.7 to 1, inclusive of 0.7 and 1, i.e. 0.7≤φ≤1.

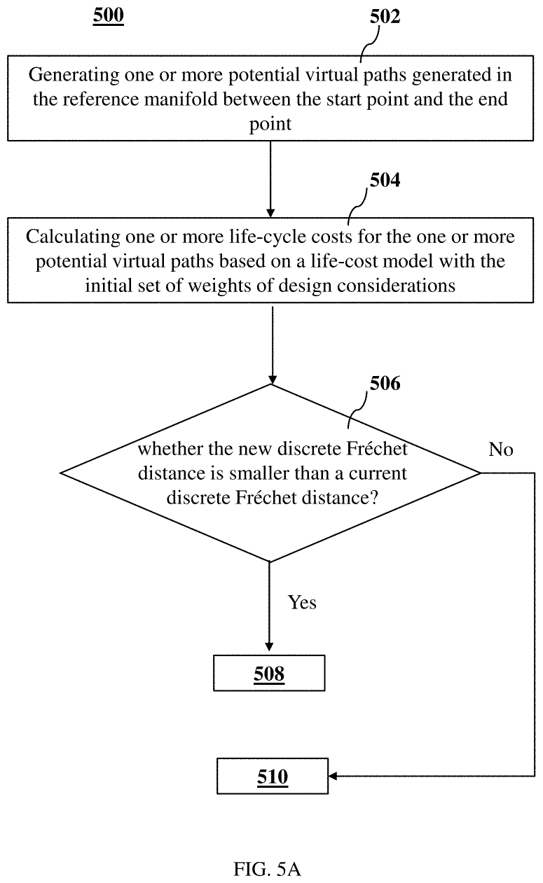

FIGS. 5A-5C depict a flowchart of an iteration 500 of the simulated annealing algorithm. Referring to FIG. 5A, the iteration process 500 comprises the following steps:

502: obtaining a new virtual path having a minimal total life-cycle cost under a new set of weights of design considerations generated by perturbating a current set of weights of design considerations which is obtained in a previously performed iteration;

504: calculating a new discrete Fréchet distance for the new virtual path with respect to the reference cable path;

506: determining whether the new discrete Fréchet distance is smaller than a current discrete Fréchet distance which is calculated in a previously performed iteration; going to a step 508 if the new discrete Fréchet distance is smaller than the current discrete Fréchet distance; and going to a step 510 if the new discrete Fréchet distance is not smaller than the current discrete Fréchet distance.

Referring to FIG. 5B. The step 508 includes: a step 5082: assigning the new set of weights of design considerations as the current set of weights of design considerations and the new discrete Fréchet distance as the current discrete Fréchet distance; a step 5084: determining whether the new discrete Fréchet distance is smaller than a best discrete Fréchet distance; and a step 5086: assigning the new set of weights of design considerations as the best set of weights of design considerations and the new discrete Fréchet distance as the best discrete Fréchet distance if the new discrete Fréchet distance is smaller than the best discrete Fréchet distance;

Referring to FIG. 5C. The step 510 includes: a step 5102: calculating an acceptance probability which is dependent on a new distance difference between the new discrete Fréchet distance and the current discrete Fréchet distance; a step 5104: determining whether the acceptance probability is smaller than an annealing temperature value T which is dependent on a number of iterations having been performed under the simulated annealing algorithm; a step 5106: assigning the new set of weights of design considerations as the current set of weights of design considerations and the new discrete Fréchet distance as the current discrete Fréchet distance if the acceptance probability is smaller than the annealing temperature value; and a step 5108: assigning the current set of weights of design considerations as the new set of weights of design considerations if the acceptance probability is greater than the annealing temperature value.

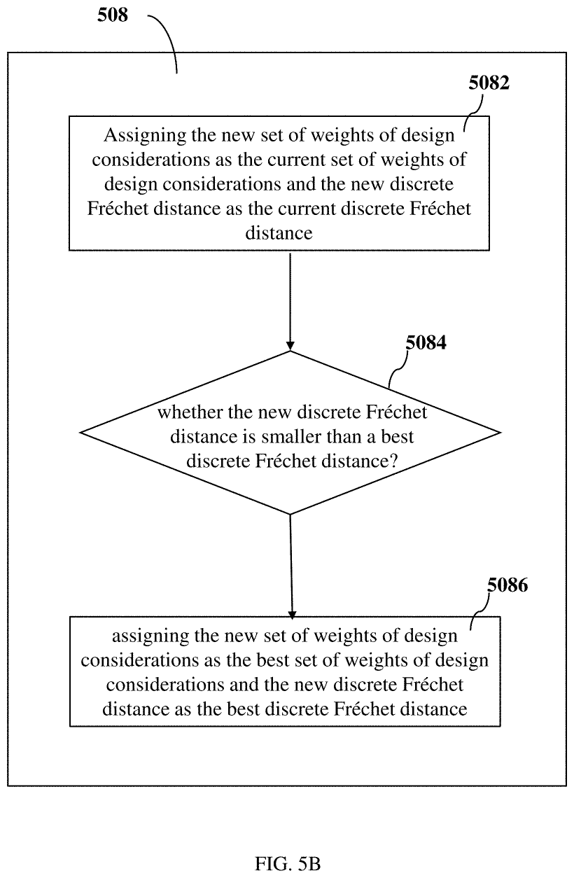

FIG. 6 shows an exemplary implementation 600 of the FMM/SA algorithm. A person skilled in the art would appreciate that the implementation 600 shown in FIG. 6 is merely exemplary, and that different implementation 600 constructed with different expressions of instructions or software codes based on the teachings of the present disclosure may still be applicable in the invention.

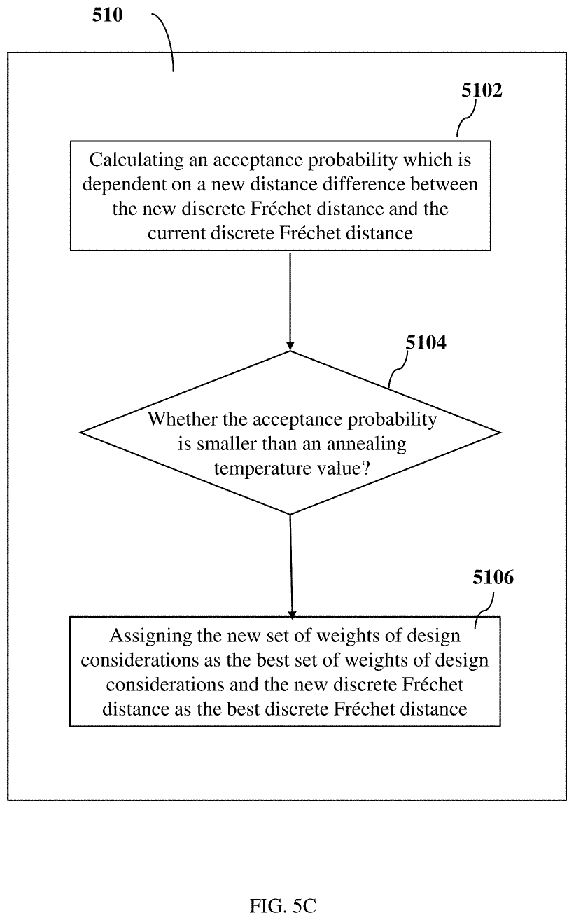

FIG. 7 shows an exemplary apparatus 700 that can be used as a server or other information processing systems in one embodiment of the invention for performing or implementing the method in the invention. For examples, the apparatus 700 may be computing devices including server computers, personal computers, laptop computers, mobile computing devices such as smartphones and tablet computers. Preferably, the apparatus 700 may have different configurations, and it generally comprises suitable components necessary to receive, store and execute appropriate computer instructions or codes. The main components of the apparatus 700 are a processing unit 702 and a memory unit 704.

The processing unit 702 is a processor such as a CPU, an MCU or electronic circuitries including but not limited to application specific integrated circuits (ASIC), field programmable gate arrays (FPGA), and other programmable logic devices configured or programmed according to the teachings of the present disclosure.

The memory unit 704 may include a volatile memory unit (such as RAM), a non-volatile unit (such as ROM, EPROM, EEPROM and flash memory) or both, or any type of media or devices suitable for storing instructions, codes, and/or data.

Preferably, the apparatus 700 further includes one or more input devices 706 such as a keyboard, a mouse, a stylus, a microphone, a tactile input device (e.g., touch sensitive screen) and a video input device (e.g., camera). The apparatus 700 may further include one or more output devices 708 such as one or more displays, speakers, disk drives, and printers. The displays may be a liquid crystal display, a light emitting display or any other suitable display that may or may not be touch sensitive. The apparatus 700 may further include one or more disk drives 712 which may encompass solid state drives, hard disk drives, optical drives and/or magnetic tape drives. A suitable operating system may be installed in the apparatus 700, e.g., on the disk drive 712 or in the memory unit 704 of the apparatus 700. The memory unit 704 and the disk drive 712 may be operated by the processing unit 702.

The apparatus 700 also preferably includes a communication module 710 for establishing one or more communication links (not shown) with one or more other computing devices such as a server, personal computers, terminals, wireless or handheld computing devices. The communication module 710 may be a modem, a Network Interface Card (NIC), an integrated network interface, a radio frequency transceiver, an optical port, an infrared port, a USB connection, or other interfaces. The communication links may be wired or wireless for communicating commands, instructions, information and/or data.

Preferably, the processing unit 702, the memory unit 704, and optionally the input devices 706, the output devices 708, the communication module 710 and the disk drives 712 are connected with each other through a bus, a Peripheral Component Interconnect (PCI) such as PCI Express, a Universal Serial Bus (USB), and/or an optical bus structure. In one embodiment, some of these components may be connected through a network such as the Internet or a cloud computing network. A person skilled in the art would appreciate that the apparatus 700 shown in FIG. 7 is merely exemplary, and that different apparatuses 700 may have different configurations and still be applicable in the invention.

In some embodiments, the method in the invention may also be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

### Application Example

This section illustrates an application example of the present invention by using a first real-life existing submarine cable path as the reference cable path for deriving an optimal set of weights of design considerations and demonstrating whether an optimal path arrangement determined with the derived optimal set of weights of design considerations for a second real-life existing submarine cable is consistent with the realistic cable path arrangement. In addition, the performance of the FMM/SA algorithm is compared to those of the FMM algorithm based on random-restart hill-climbing (the FMM/RRHC algorithm) and the FMM algorithm based on Monte Carlo's idea (the FMM/MC algorithm).

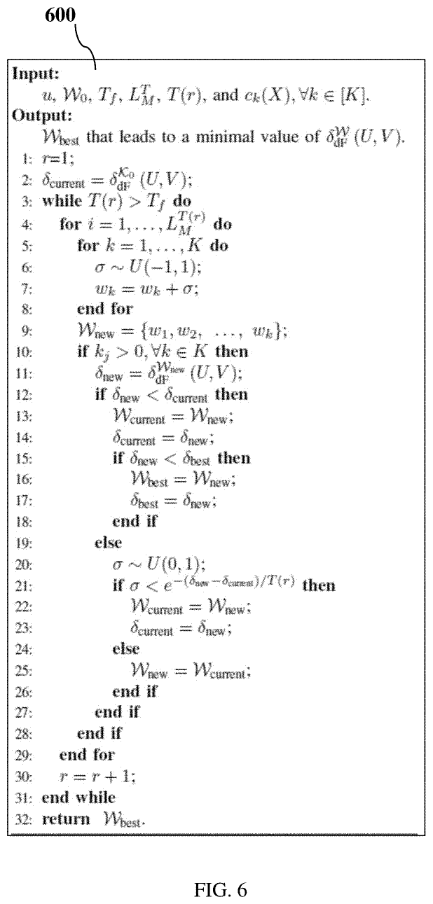

The first real-life existing submarine cable path is from the Southern Cross NEXT located in the Pacific Ocean and comprising a Trans-Pacific trunk route linking Coogee Beach, Australia with Hermosa Beach, Calif. USA, and branches to Takapuna Beach, New Zealand, to Suva, to Savusavu, to Apia, to Tokelau, and also a link to Kiribati. FIG. 8A illustrates the topology of the Southern Cross NEXT. The longest segment of this submarine cable system is selected as the first real-life existing cable path (denoted by Cable SX). The Cable SX has a start point (34.053389° N, 118.245335° W) on Hermosa Beach (USA) and an end point at (5.062067° N, 160.200084° W). FIG. 8B shows the Cable SX drawn using a web-based mapping software (e.g., ArcGIS). The start point of Cable SX is represented as a red dot, while the end point of the Cable SX is represented as a black dot.

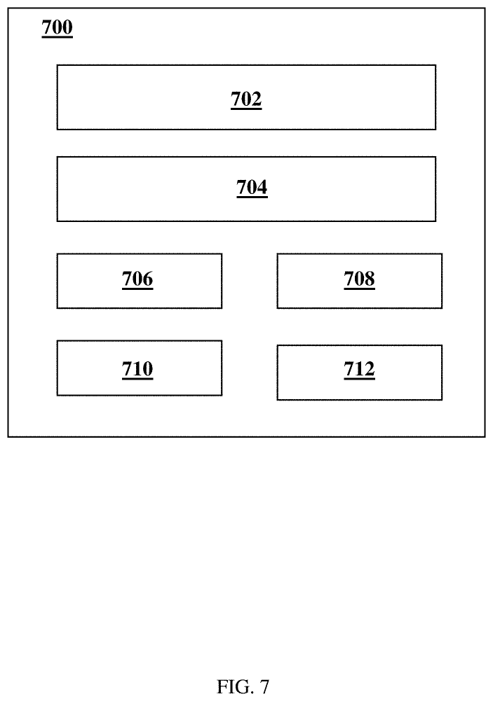

The second real-life existing submarine cable path is from the South America-1 (SAm-1) cable network located in Latin America, connecting the United States, Puerto Rico, Brazil, Argentina, Chile, Peru and Guatemala. FIG. 9A shows the topology of the South America-1. The cable segment that connects San Juan (Puerto Rico) and Boca Raton (USA) is selected as the second real-life existing cable path (denoted by Cable SAm). FIG. 9B shows the Cable SAm drawn using ArcGIS. The start point of Cable SAm is represented as a red dot while the end point of the Cable SX is represented as a black dot.

In calculating the life-cycle cost of each point X (x, y, z) on a submarine cable path, the following design considerations that contribute to the total life-cycle cost of the submarine cable path are taken into account (Notice that the units “dollars ($)” representing the total life-cycle cost should not be taken as the actual prediction for the cable cost, because they are a measure obtained as a summary cost function which is based on the various costs associated with the design considerations and their weights (that are subjective measures of importance)):

1) Basic construction cost c₁ (X). It involves the laying, maintenance and removal cost of submarine cables. By way of example and not limitation, c₁(X) may be defined as constant number, that is, c₁(X)=27,000 $.

2) Geological hazards c₂(X), specifically, earthquakes with magnitudes greater than 4.5 and volcanic eruption. By way of example and not limitation, assuming that there are p earthquakes and q volcanic eruptions in total in target region T, the cost c₂ (X) may be defined as:

c₂(X)=Σᵢ_{ₑ}₌₁^{p}cₑ(X,iₑ)+Σᵢ_{ᵥ}₌₁^{q}cᵥ(X,iᵥ),

where cₑ(X, iₑ) and cᵥ(X, iᵥ) are the cost caused by earthquake iₑ and a volcanic eruption iᵥ.

The cost cₑ(X, iₑ) may be given by:

cₑ(X,iₑ)=a₁e^{1.3 ln PGV(X)-7.21}, and

PGV(X)=2.04+0.422×(M_{w}−6)−0.0373×(M_{w}−6)²−log_{10 i d}(X,iₑ),

which represents the peak ground velocity (PGV) at location X,

where M_{w} and d(X, iₑ) are the earthquake magnitude of iₑ and the distance between point X and earthquake iₑ, respectively.

The cost cᵥ(X, iᵥ) may be given by:

$${c}_{v} ( X , {i}_{v} ) = \{ \begin{matrix}{a}_{2} , if d ( X , {i}_{v} ) \leq 3 km , \\ {a}_{2} {e}^{3 - 2 d ( X , {i}_{v} )} , otherwise ,\end{matrix}$$

where a₂ is a very large number for avoiding these volcanos and d(X, iᵥ) is the distance between point X and volcano iᵥ, respectively.

3) Seabed slope c₃(X). By way of example and not limitation, the cost c₃(X) may be defined as:

$${c}_{3} ( X ) = \{ \begin{matrix}{a}_{3} {e}^{{l}_{1} ( X ) - 20} , if {l}_{1} ( X ) > {20}^{o} , \\ \frac{{a}_{3} ( {l}_{1} ( X ) - 10 )}{10} , if {20}^{o} \geq {l}_{1} ( X ) \geq {10}^{o} , \\ 0 , otherwise ,\end{matrix}$$

where a₃ is a very large number for avoiding steep areas and l₁(X) is the slope at location X.

4) Water depth c₄(X). By way of example and not limitation, the cost c₄(X) may be defined as:

$${c}_{4} ( X ) = \{ \begin{matrix}{a}_{4} , if {l}_{2} ( X ) \leq 0 , \\ {a}_{4} {e}^{- 4 {l}_{2} ( X )} , if 1 km \geq {l}_{2} ( X ) \geq 0 , \\ {a}_{4} {e}^{- 3 - {l}_{2} ( X )} , otherwise ,\end{matrix}$$

where a₄ is a very large number for avoiding placing cable on the land and l₂ (X) is the water depth at location X. Note that l₂(X)<0 means that the location X is underwater.

5) Anthropological hazards c₅(X), specifically, fishing and anchoring activities. By way of example and not limitation, the cost c₅(X) may be defined as:

c₅(X)=c_{f}(X)+cₐ(X),

where c_{f}(X) and cₐ(X) are the cost caused by fishing and anchoring activities, respectively.

The cost c_{f}(X) may be defined as:

$${c}_{f} ( X ) = \{ \begin{matrix}0 , if {l}_{2} ( X ) \leq 0 , \\ 0.001725 {a}_{5} , if 0 \leq {l}_{2} ( X ) \leq 0.3 , \\ 0.000275 {a}_{5} , if 0.3 \leq {l}_{2} ( X ) \leq 1 , \\ 0.0001 {a}_{5} , otherwise ,\end{matrix}$$

and the cost cₐ(X) may be defined as:

$${c}_{a} ( X ) = \{ \begin{matrix}0 , if {l}_{2} ( X ) \leq 0 , \\ 0.000575 {a}_{5} , if 0 \leq {l}_{2} ( X ) \leq 0.3 , \\ 0.00005 {a}_{5} , otherwise ,\end{matrix}$$

where a₅ is a very large number for avoiding the shallow water area.

6) Protected areas c₆(X), specifically, seagrass and coral areas. By way of example and not limitation, the cost c₆(X) may be defined as:

$${c}_{6} ( X ) = \{ \begin{matrix}{a}_{6} , if X is located in the protected area , \\ 0 , otherwise ,\end{matrix}$$

where a₆ is a very large number for avoiding these protected areas.

Accordingly, the importance (weights) of the design considerations (1)-(6) above may be denoted as W={w₁, w₂, w₃, w₄, w₅, w₆}. By implementing these weights, the life-cycle cost per unit length of the cable passing through location X may be represented as C(X)=Σᵢ₌₁⁶ wᵢcᵢ(X). In this application example, the initial set of weights W₀ is set to be {0.28, 0.091, 0.35, 0.091, 0.09, 0.0981}. The numbers a₁, a₂, a₃, a₄, a₅, a₆ are all set to be 3×10⁶$.

Data of the design considerations for the two real-life existing submarine cable paths can be obtained from public data sources or web-based mapping software. For example, geological data (that is, longitude, latitude, and elevation) at each point on the paths can be obtained from worldwide submarine cable map (e.g., Infrapedia, https://www.infrapedia.com/app/subsea-cable/). The global terrain data for ocean and land is available in the General Bathymetric Chart of the Oceans (GEBCO, https://www.gebco.net) at 15 arc-second intervals. This data can provide a triangulated manifold model M with the distance between two adjacent grid points in the range of 350 to 650 meters. The seabed slope data and water depth data are calculated from the global terrain data. The earthquake data is provided by United States Geological Survey (USGS, https://earthquake.usgs.gov/). The information on volcano eruptions is obtained from National Oceanic and Atmospheric Administration (NOAA, https://www.ngdc.noaa.gov/). The protected areas for seagrass and corals are derived from World Conservation Monitoring Centre (WCMC, https://data.unep-wcmc.org/datasets/).

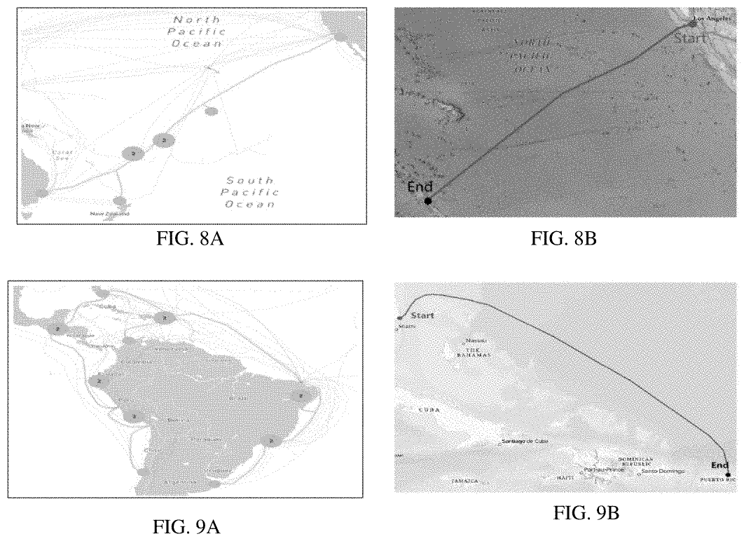

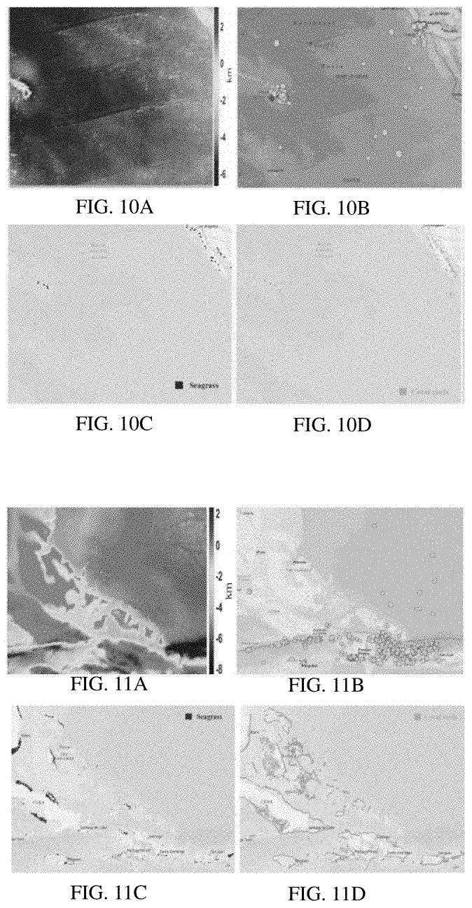

FIGS. 10A-10D show elevation map, geological hazards, seagrass map and coral beefs map around Cable SX, respectively. FIGS. 11A-11D show elevation map, geological hazards, seagrass map and coral beefs map around Cable SAm, respectively.

The parameter setting of cooling schedule of the FMM/SA algorithm is shown in Table 1. A sufficiently high initial temperature (T₀=500) is selected to avoid falling into the local optimum. A sufficiently low termination temperature (T_{f}=5) is selected to avoid poor accuracy. The dimension of the state space D is set to be 2, and non-negative real number φ is set to be 0.8 such that the annealing temperature function is given by: T(r)=T₀*0.8^{r}^{^{1/2}}.

TABLE 1
Cooling schedule of the FMM/SA.

| Parameter | Value |
|---|---|
| T₀ | 500 |
| T_{f} | 5 |
| T(r) | T(r) = T₀ + 0.8^{r}^{^{1/2}} |

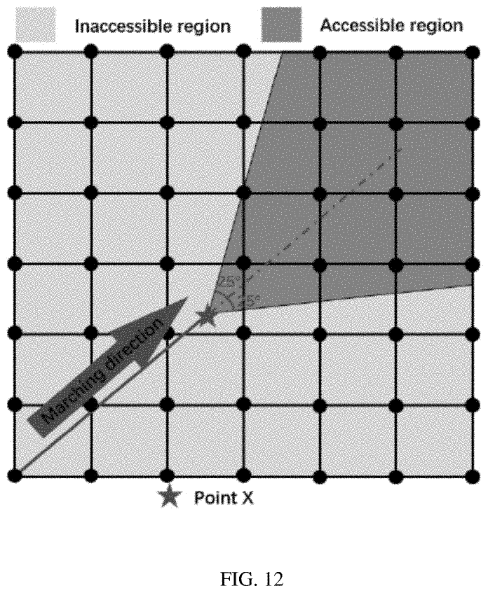

Under an International Cable Protection Committee Ltd (“ICPC”) Recommendation (https://www.iscpc.org/publications/recommendations/), the cable path generated by the FMM/SA algorithm is set to march in only the 50-degree fan-shaped range in front of the current direction during the marching process as shown in FIG. 12.

Table II provides the detailed Fréchet distances and total lengths of minimal life-cycle cost paths (denoted as Cables 1-4) generated by the FMM/SA algorithm under different sets of weights of design considerations obtained at different running times. Cable 1 is the optimal cable path obtained while Cables 2-4 are the intermediate results. All the results are obtained using a Dell G7-7590 laptop (32 GB RAM, 2.60 GHz Intel® Core™ i7-9750H CPU) for running the codes in Matlab R2017b.

TABLE 2
Results of FMM/SA.

| | | | | Total life- |
|---|---|---|---|---|
| | Fréchet distance | Running | Total | cycle cost |
| | with Cable SX | time | Length | (millions of |
| | (kilometers) | (seconds) | (kilometers) | dollars) |
| Cable SX | 0 | NA | 5351.1 | 1112.58 |
| Path 1 | 1.856 | 15411 | 5352.8 | 1113.21 |
| Path 2 | 5.994 | 5462 | 5356.3 | 1113.84 |
| Path 3 | 55.275 | 75 | 5403.5 | 1125.75 |
| Path 4 | 241.370 | 15 | 5578.3 | 1150.06 |

It can be seen from Table 2 that, as time used to assess the weights increases, the closer our cable path is to Cable SX, but the time required to make further improvements in getting closer to Cable SX will increase greatly.

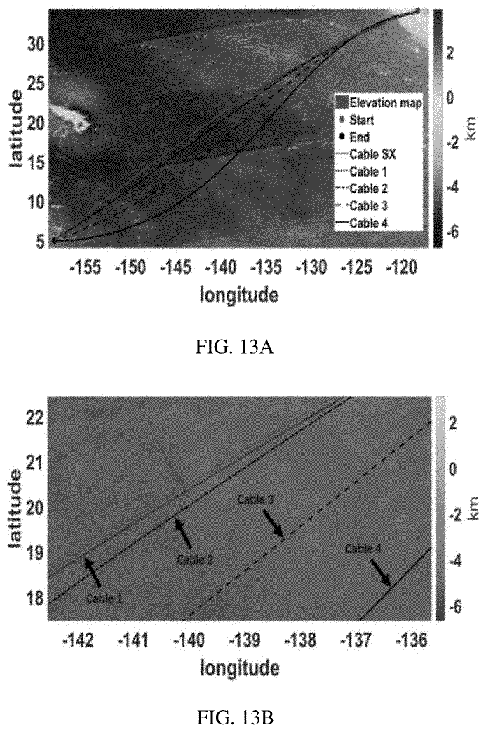

FIG. 13A shows the curves of Cables 1-4 and Cable SX plotted on an elevation map around the Cable SX. It can be seen in FIG. 13A that as the running time increases, the curve of the generated cable path keeps getting closer to the curve of Cable SX, and the Fréchet distance between Cable SX and the curve of generated cable path keeps decreasing. Compared with Cables 2-4, Cable 1 is almost overlapped with Cable SX, meaning a relatively good result has been achieved.

A partially enlarged view of FIG. 13A is given in FIG. 13B, which shows the difference between the various curves more clearly. Note that although Cable 1 and Cable SX are very close to each other and almost overlapped, the Fréchet distance between them is still not 0 (see in Table 2). This is because there are more considerations in the design process of Cable SX whereas only the considerations with public data are considered in this case. Better results (closer to Cable SX than Cable 1) will be obtained if data of more design considerations is provided.

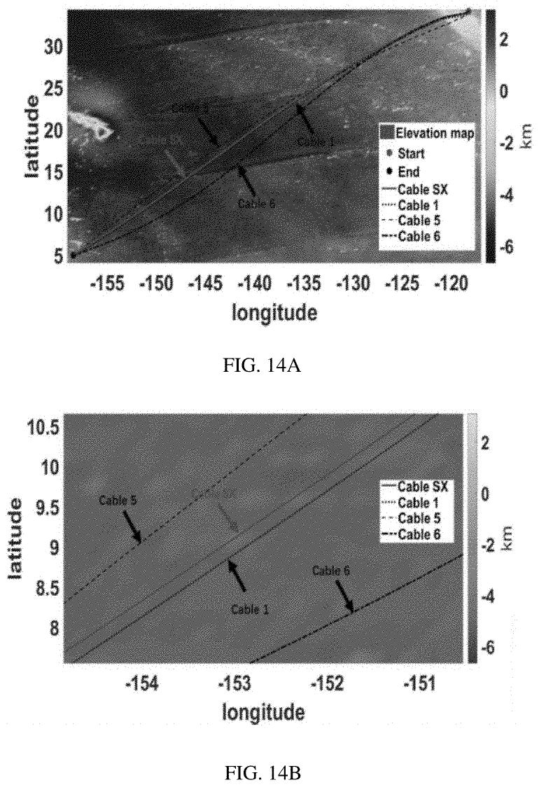

Tables 3 and 4 show numerical results for the cable paths generated by FMM/SA algorithm (Cable 1), the FMM/RRHC algorithm (Cable 5) and the FMM/MC algorithm (Cable 6) compared with the data of Cable SX, respectively. Noted that the total life-cycle cost for Cable SX is different in Table 3 and 4 because these two tables use different W derived by FMM/RRHC and FMM/MC, respectively. FIG. 14A shows curves of Cables 1, 5-6 and Cable SX plotted on an elevation map around the Cable SX. A partially enlarged view of FIG. 14A is given in FIG. 14B. Table 5 shows W_{best} values which can generate the closest paths with Cable SX by the FMM/SA, FMM/RRHC and FMM/MC algorithms.

It can be clearly seen that FMM/SA algorithm can better solve this problem within the limited time. Given the data of a submarine cable path in the real world and the cost functions of all the design considerations, FMM/SA algorithm can continuously approach the actual submarine cable curve (Cable SX) at a faster speed. In contrast, FMM/MC algorithm takes nearly 50,000 seconds to find the path result (Cable 6), which is comparable with Cable 3 by FMM/SA algorithm taking only 75 seconds. Although FMM/RRHC algorithm obtains a path result (Cable 5) closer to that of FMM/SA algorithm (Cable 1), it takes much more time to obtain the results.

TABLE 3
Results of FMM/RRHC.

| | | | | Total life- |
|---|---|---|---|---|
| | Fréchet distance | Running | Total | cycle cost |
| | with Cable SX | time | Length | (millions of |
| | (kilometers) | (seconds) | (kilometers) | dollars) |
| Cable SX | 0 | NA | 5351.1 | 1215.04 |
| Path 5 | 9.732 | 31776 | 5359.6 | 1217.61 |

TABLE 4
Results of FMM/MC.

| | | | | Total life- |
|---|---|---|---|---|
| | Fréchet distance | Running | Total | cycle cost |
| | with Cable SX | time | Length | (millions of |
| | (kilometers) | (seconds) | (kilometers) | dollars) |
| Cable SX | 0 | NA | 5351.1 | 1055.08 |
| Path 6 | 38.136 | 50297 | 5387.5 | 1063.32 |

TABLE 5
W_{best} values for design considerations by FMM/SA
(Path 1), FMM/RRHC (Path 5), and FMM/MC (Path 6).

| | FMM/SA | FMM/RRHC | FMM/MC |
|---|---|---|---|
| w₁ | 0.1695 | 0.1697 | 0.1321 |
| (Basic construction cost) | | | |
| w₂ | 0.3852 | 0.4720 | 0.4324 |
| (Geological hazards) | | | |
| w₃ | 0.1645 | 0.1756 | 0.1766 |
| (Seabed slope) | | | |
| w₄ | 0.0215 | 0.0229 | 0.0235 |
| (Water depth) | | | |
| w₅ | 0.0739 | 0.0895 | 0.0809 |
| (Anthropological hazards) | | | |
| w₆ | 0.1851 | 0.0703 | 0.1545 |
| (Protected areas) | | | |

Based on the optimal set of weights of design considerations derived with the first real-life existing submarine cable, Cable SX, an optimal path arrangement on the second real-life existing submarine cable, Cable SAm, is determined and compared with the realistic cable path arrangement.

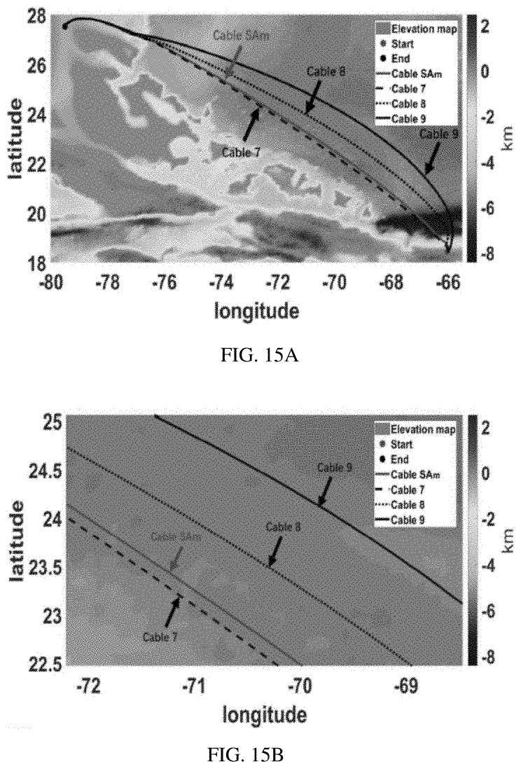

Table 6 provides the detailed Fréchet distances and total lengths of the cable paths generated under the optimal set of weights of design considerations obtained by the FMM/SA algorithm, the FMM/RRHC algorithm (Cable 8) and FMM/MC algorithm, respectively. Cable 7 is the cable path generated under the optimal set of weights of design considerations obtained by the FMM/SA algorithm. Cable 8 is the cable path generated under the optimal set of weights of design considerations obtained by the FMM/RRHC algorithm. Cable 9 is the cable path generated using weights of design considerations obtained by the FMM/MC algorithm. Note that in Table 6, total life-cycle costs are normalized by setting the total life-cycle cost for Cable SAm to 1 for easy comparison among Paths 7, 8, and 9. FIG. 15A shows curves of Cables 7-9 and Cable SAm plotted on an elevation map around the Cable SAm. A partially enlarged view of FIG. 15A is given in FIG. 15B.

TABLE 6
Results of cable paths generated by FMM using
weights derived from FMM/SA (Path 7), FMM/RRHC
(Path 8) and FMM/MC (Path 9).

| | Fréchet distance | Total | Normalized |
|---|---|---|---|
| | with Cable SAm | Length | total life- |
| | (kilometers) | (kilometers) | cycle cost) |
| Cable SAm | 0 | 1791.2 | 1 |
| Path 7 | 3.341 | 1788.8 | 0.9928 |
| Path 8 | 40.937 | 1825.0 | 1.0304 |
| Path 9 | 104.682 | 1877.1 | 1.0833 |

From the results shown in Table 6 and FIGS. 15A-15B, it can be clearly seen that Cable 7 generated under the weights obtained from FMM/SA is much closer to the second real-life existing cable path, Cable SAm. FMM/SA algorithm is then proved to have the superiority among these alternatives. The present invention can provide a cable path that achieves consistency of all the design considerations with that of the real-life existing cable path (Cable SAm).

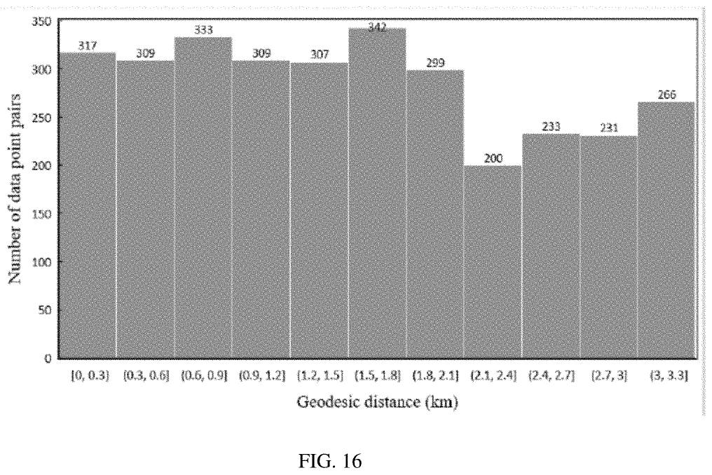

The above application example demonstrates that learning the weights of design considerations from the 5,351.1 kilometer-long (with over 9,000 data points) Cable SX in one part of the world (Pacific Ocean), and then using these weights for cable path planning between the end-points of the 1,791.2 kilometers-long Cable SAm in a different part of the world (Latin America) can provide a path (Path 7) that is very close to the actual real-life path of Cable SAm derived based on the traditional approach. FIG. 16 shows a histogram of the geodesic distances between the data points from Cable SAm and Path 7 (with over 3,000 data points). These results provide a certain indication that the weights of design considerations are to a certain extent independent of the location of the cable and consistently close matching can be achieved.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A computer-implemented method for planning cable path of an infrastructure cable over a target terrain, comprising:
deriving, by one or more processors, an optimal set of weights of design considerations from an optimal virtual cable path generated between a reference start point and a reference end point in a reference manifold under an objective of minimizing a life-cycle cost modelled with one or more design considerations and minimizing a discrete Fréchet distance with respect to a reference cable path; and
determining, by the one or more processors, an optimal path arrangement for the infrastructure cable over the target terrain based on the derived optimal set of weights of design considerations.

2. The computer-implemented method according to claim 1, wherein:
the reference cable path is extracted from a real-life submarine cable between two geographic locations;
the reference start point and the reference end point are defined as the two geographic locations, respectively; and
the reference manifold is a triangulated piecewise-linear two-dimensional manifold obtained by modelling an earth surface between the two geographic locations.

3. The computer-implemented method according to claim 1, wherein the derivation of the optimal set of weights of design considerations comprises:
obtaining an initial virtual path having a minimal total life-cycle cost under an initial set of weights of design considerations by applying a fast marching method;
perturbing the initial set of weights of design considerations and applying a simulated annealing algorithm to obtain a best set of weights of design considerations contributing to a best virtual path which has a minimal discrete Fréchet distance with respect to the reference cable path; and
returning the best set of weights of design considerations as the optimal set of weights of design considerations.

4. The computer-implemented method according to claim 3, the fast marching method applied for obtaining the initial virtual path comprises:
generating one or more potential virtual paths generated in the reference manifold between the start point and the end point;
calculating one or more life-cycle costs for the one or more potential virtual paths based on a life-cost model with the initial set of weights of design considerations;
determining a potential virtual path which has the smallest life-cycle cost as the initial virtual path.

5. The computer-implemented method according to claim 3, wherein the simulated annealing algorithm for obtaining the best set of weights of design considerations comprises:
setting a cooling schedule consists of an initial cooling temperature, a termination temperature of cooling, a number of annealing temperatures between the initial cooling temperature and the termination temperature; and a maximum number of iterations to be formed at each annealing temperature; and
performing iterations at each annealing temperature.

6. The computer-implemented method according to claim 5, wherein each iteration comprises:
obtaining a new virtual path having a minimal total life-cycle cost under a new set of weights of design considerations generated by perturbating a current set of weights of design considerations which is obtained in a previously performed iteration;
calculating a new discrete Fréchet distance for the new virtual path with respect to the reference cable path;
determining whether the new discrete Fréchet distance is smaller than a current discrete Fréchet distance which is calculated in a previously performed iteration;
if the new discrete Fréchet distance is smaller than the current discrete Fréchet distance, performing:
assigning the new set of weights of design considerations as the current set of weights of design considerations and the new discrete Fréchet distance as the current discrete Fréchet distance;
determining whether the new discrete Fréchet distance is smaller than a best discrete Fréchet distance;
assigning the new set of weights of design considerations as the best set of weights of design considerations and the new discrete Fréchet distance as the best discrete Fréchet distance if the new discrete Fréchet distance is smaller than the best discrete Fréchet distance; and
if the new discrete Fréchet distance is greater than the current discrete Fréchet distance, performing:
calculating an acceptance probability which is dependent on a new distance difference between the new discrete Fréchet distance and the current discrete Fréchet distance;
determining whether the acceptance probability is smaller than an annealing temperature value which is dependent on a number of iterations having been performed under the simulated annealing algorithm;
assigning the new set of weights of design considerations as the current set of weights of design considerations and the new discrete Fréchet distance as the current discrete Fréchet distance if the acceptance probability is smaller than the annealing temperature value; and
assigning the current set of weights of design considerations as the new set of weights of design considerations if the acceptance probability is greater than the annealing temperature value.

7. The computer-implemented method according to claim 1, wherein the one or more design considerations include any one or any combination of basic construction cost, geological hazards, water depth, seabed slope, anthropological hazards and protected areas.

8. The computer-implemented method according to claim 1, further comprising: displaying, at a display operably connected with the one or more processors, the optimal path arrangement for the infrastructure cable on a map of the target terrain.

9. An apparatus for planning cable path of an infrastructure cable over a target terrain, comprising:
one or more processors configured to:
derive an optimal set of weights of design considerations from an optimal virtual cable path generated between a reference start point and a reference end point in a reference manifold under an objective of minimizing a life-cycle cost modelled with one or more design considerations and minimizing a discrete Fréchet distance with respect to a reference cable path; and
determine an optimal path arrangement for the infrastructure cable over the target terrain based on the derived optimal set of weights of design considerations.

10. The apparatus according to claim 9, further comprising a display connected with the one or more processors and configured to display the optimal path arrangement for the infrastructure cable on a map of the target terrain.

11. A non-transitory computer readable medium for storing computer instructions that, when executed by one or more processors, causes the one or more processors to perform a method for planning cable path of an infrastructure cable over a target terrain, the method comprising:
deriving, by one or more processors, an optimal set of weights of design considerations from an optimal virtual cable path generated between a reference start point and a reference end point in a reference manifold under an objective of minimizing a life-cycle cost modelled with one or more design considerations and minimizing a discrete Fréchet distance with respect to a reference cable path; and
determining, by the one or more processors, an optimal path arrangement for the infrastructure cable over the target terrain based on the derived optimal set of weights of design considerations.
